(19) United States
(12) Patent Application Publication
(10) Pub. No.: US 2011/0106338 A1
(43) Pub. Date: May 5, 2011

(54) Remote Vehicle Control System and Method

(76) Inventors: Daniel P. Allis, Lynn, MA (US); Robert Todd Pack, Nashua, NH (US)

(21) Appl. No.: 12/916,482

(22) Filed: Oct. 29, 2010

Related U.S. Application Data
(60) Provisional application No. 61/256,178, filed on Oct. 29, 2009.

(51) Int. Cl. G06F 7/00; G05D 1/00

(52) U.S. Cl. 701/2

(57) ABSTRACT

A system for increasing an operator's situational awareness while the operator controls a remote vehicle using an autonomous behavior and/or a semi-autonomous behavior. The system includes a payload attached to the remote vehicle and in communication with the remote vehicle and the operator control unit. The payload comprises: an integrated sensor suite including a global positioning system, an inertial measurement unit, one or more video cameras, and a stereo vision camera or a range sensor; and a computational module receiving data from the integrated sensor suite, performing computations on at least some of the data, analyzing at least some of the data, and providing data to at least one of the autonomous behavior and the semi-autonomous behavior.

This application claims the right to priority based on Provisional Patent Application no. 61/256,178, filed Oct. 29, 2009, the entire content of which is incorporated herein by reference.

### FIELD

The present teachings relate to a system and method for increasing remote vehicle operator effectiveness and situational awareness. The present teachings relate more specifically to a system comprising an operator control unit (OCU), a payload, and customized OCU applications that increase remote vehicle operator effectiveness and situational awareness.

### BACKGROUND

A compelling argument for military robotics is the ability of robots to multiply the effective force or operational capability of an operator while simultaneously limiting the operator's exposure to safety risks during hazardous missions. The goals of force multiplication and increased operator capability have arguably not been fully realized due to the lack of autonomy in fielded robotic systems. Because low-level teleoperation is currently required to operate fielded robots, nearly 100% of an operator's focus may be required to effectively control a robotic system that may be a fraction as effective as the soldier. Teleoperation usually shifts the operator's focus away from his own position to the robot, which can be over 800 meters away to gain safety through increased stand-off distance. Thus, mission effectiveness may be sacrificed for standoff range.

### SUMMARY

The present teachings provide a system for increasing an operator's situational awareness while the operator controls a remote vehicle. The system comprises: an operator control unit having a point-and-click interface configured to allow the operator to view an environment surrounding the remote vehicle and control the remote vehicle by inputting one or more commands via the point-and-click interfaced; and a payload attached to the remote vehicle and in communication with at least one of the remote vehicle and the operator control unit. The payload comprises an integrated sensor suite including a global positioning system, an inertial measurement unit, and a stereo vision camera or a range sensor; and a computational module receiving data from the integrated sensor suite and providing data to at least one of an autonomous behavior and a semi-autonomous behavior.

The present teachings also provide a system for increasing an operator's situational awareness while the operator controls a remote vehicle using an autonomous behavior and/or a semi-autonomous behavior. The system includes a payload attached to the remote vehicle and in communication with the remote vehicle and the operator control unit. The payload comprises: an integrated sensor suite including a global positioning system, an inertial measurement unit, one or more video cameras, and a stereo vision camera or a range sensor; and a computational module receiving data from the integrated sensor suite, performing computations on at least some of the data, analyzing at least some of the data, and providing data to at least one of the autonomous behavior and the semi-autonomous behavior.

The present teachings further provide a system for performing explosive ordnance disposal with a small unmanned ground vehicle using at least one of an autonomous behavior and a semi-autonomous behavior. The system includes a payload attached to the remote vehicle and in communication with the remote vehicle and the operator control unit. The payload comprises: an integrated sensor suite including a global positioning system, an inertial measurement unit, one or more video cameras, and a stereo vision camera or a range sensor; and a computational module receiving data from the integrated sensor suite, performing computations on at least some of the data, analyzing at least some of the data, and providing data to at least one of the autonomous behavior and the semi-autonomous behavior. Commands are sent from the OCU to the remote vehicle via the payload.

Additional objects and advantages of the present teachings will be set forth in part in the description that follows, and in part will be obvious from the description, or may be learned by practice of the teachings. The objects and advantages of the present teachings will be realized and attained by means of the elements and combinations particularly pointed out in the appended claims.

It is to be understood that both the foregoing general description and the following detailed description are exemplary and explanatory only and are not restrictive of the present teachings, as claimed.

The accompanying drawings, which are incorporated in and constitute a part of this specification, illustrate exemplary embodiments of the present teachings and, together with the description, serve to explain the principles of the present teachings.

### BRIEF DESCRIPTION OF THE DRAWINGS

FIG. 1 is a schematic diagram of an exemplary embodiment of a high-level system architecture for a system in accordance with the present teachings.

FIG. 2 is a schematic diagram of an exemplary embodiment of a system architecture for a payload in accordance with the present teachings.

FIG. 3 is a schematic diagram of an exemplary embodiment of integration of an advanced behavior engine and a JAUS gateway in accordance with the present teachings.

FIG. 4 illustrates an exemplary embodiment of a point-and-click interface in accordance with the present teachings.

FIG. 5 is a plan view of an exemplary embodiment of a remote vehicle including a payload in accordance with the present teachings.

FIG. is a plan view of an exemplary embodiment of a payload in accordance with the present teachings.

FIG. 7 is an exploded view of the payload embodiment of FIG. 6.

### DESCRIPTION OF THE EMBODIMENTS

Reference will now be made in detail to exemplary embodiments of the present teachings, examples of which are illustrated in the accompanying drawings. Wherever possible, the same reference numbers will be used throughout the drawings to refer to the same or like parts.

The present teachings provide a small, lightweight (e.g., less than about 10 pounds and preferably less than about 5 pounds), supervisory autonomy payload capable of providing supervisory control of a previously teleoperated small unmanned ground vehicle (SUGV), for example used for explosive ordnance disposal (EOD) missions. The present teachings also provide an appropriately-designed map-based “point-and-click” operator control unit (OCU) application facilitating enhanced, shared situational awareness and seamless access to a supervisory control interface. The SUGV can comprise, for example, an iRobot® SUGV 310, which is an EOD robotic platform. A pan/tilt mechanism can be employed to allow the payload to pan and tilt independently.

A system and method in accordance with the present teachings can provide improved situational awareness by displaying a shared 3D perceptual space and simplifying remote vehicle operation using a supervisory control metaphor for many common remote vehicle tasks. Thus, an operator can task the remote vehicle on a high level using semi-autonomous and/or autonomous behaviors that allow the operator to function as a supervisor rather than having to teleoperate the vehicle. Integration of shared situational awareness can be facilitated by a 3D local perceptual space and point-and-click command and control for navigation and manipulation including target distance estimations. Local perceptual space gives a remote vehicle a sense of its surroundings. It can be defined as an egocentric coordinate system encompassing a predetermined distance (e.g., a few meters in radius) centered on the remote vehicle, and is useful for keeping track of the remote vehicle's motion over short space-time intervals, integrating sensor readings, and identifying obstacles to be avoided. A point-and-click interface can be used by an operator to send commands to a remote vehicle, and can provide a shared, graphical view of the tasking and 3D local environment surrounding the remote vehicle.

The present teachings combine supervisory control behaviors in an integrated package with on-board sensing, localization capabilities, JAUS-compliant messaging, and an OCU with an interface that can maximize the shared understanding and utilization of the remote vehicle's capabilities. The resulting system and method can reduce operator effort, allowing an operator to devote more attention to personal safety and the EOD mission. In addition, autonomous and/or semi-autonomous remote vehicle behaviors can be employed with the present teachings to improve the reliability of EOD remote vehicles by, for example, preventing common operator error and automating trouble response. Further, by providing a suite of behaviors utilizing standard sensors and a platform-agnostic JAUS-compliant remote vehicle control architecture, the present teachings can provide a path for interoperability with future JAUS-based controllers and legacy EOD systems.

Certain embodiments of the present teachings can provide JAUS reference architecture compliant remote vehicle command, control and feedback with the payload acting as a JAUS gateway. Standard JAUS messages are employed where they cover relevant functionality. Experimental messages can be utilized to provide capabilities beyond those identified in JAUS reference architecture.

A system in accordance with the present teachings can comprise a sensory/computational module and an OCU and customized software applications. The sensory/computational module can include an integrated suite of a global positioning system (GPS), an inertial measurement unit (IMU), video, and range sensors that provide a detailed and accurate 3D picture of the environment around the remote vehicle, which can enable the use of sophisticated autonomous and/or semi-autonomous behaviors and reduce the need for real-time, “high-bandwidth” and highly taxing operator micromanagement (e.g., teleoperation) of the remote vehicle. The autonomous and/or semi-autonomous behaviors can include special routines for, for example: navigation (e.g., click-to-drive); manipulation (e.g., click-to-grip); obstacle detection and obstacle avoidance (ODOA); resolved end-effector motion (e.g., fly-the-gripper); retrotraverse; and self-righting in the event that the remote vehicle has rolled over and can physically provide the actuation necessary for self righting. The OCU includes an application to manage control and feedback of the payload and integrate the payload with a platform (e.g., an iRobot® SUGV 310), which allows the OCU to talk to, direct, and manage the payload, and then the payload can command the remote vehicle based on commands received from the OCU. In accordance with certain embodiments, all commands from the OCU are related to the remote vehicle via the payload.

In situations where the remote vehicle is out of sight, map-based localization and a shared 3D local perceptual space can provide the operator with real-time feedback regarding the remote vehicle's position, environment, tasking, and overall status.

Certain embodiments of the present teachings provide: (1) a software architecture that supports a collection of advanced, concurrently-operating behaviors, multiple remote vehicle platforms, and a variety of sensor types; (2) deployable sensors that provide sufficient information to support the necessary level of shared situational awareness between the remote vehicle operator and the on-board remote vehicle autonomy features; (3) lightweight, low-power, high-performance computation that closes local loops using sensors; and (4) a human interface that provides both enhanced situational awareness and transparent tasking of remote vehicle behaviors. Closing local loops refers to the fact that computations and data analyses can be done locally (in the payload) based on sensor feedback, and the payload can then send the results of the computation and/or analysis to the remote vehicle as a command. The payload can also monitor the remote vehicle's progress to ensure the remote vehicle completed the tasks in the command, so that the operator does not have to monitor the remote vehicle's progress.

Certain embodiments of a system in accordance with the present teachings can also comprise a digital radio link built into the OCU configuration and the payload to simplify integration and performance.

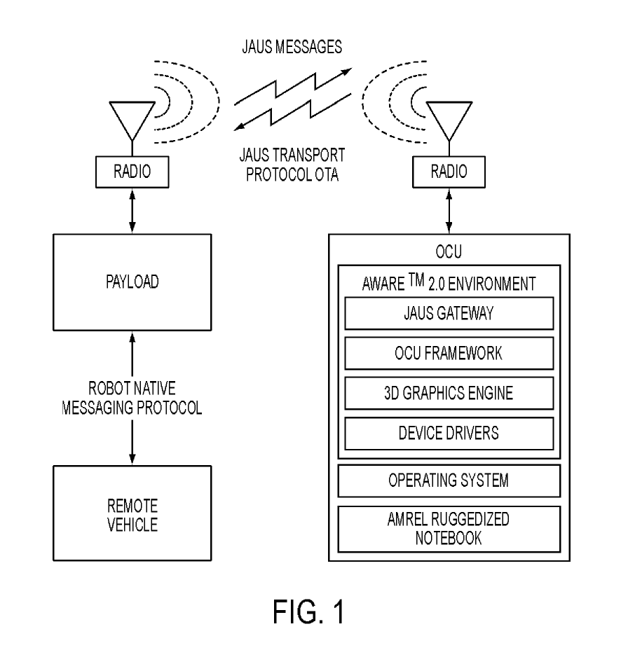

FIG. 1 is a schematic diagram of an exemplary embodiment of a high-level system architecture for a system in accordance with the present teachings. As illustrated, the system can include a payload in communication with a remote vehicle and in communication with an OCU. The payload and the remote vehicle can communicate with the OCU via the same communication link or separate communication links. Certain embodiments of the present teachings provide communication with the OCU via, at least in part, JAUS messages and an over-the-air (OTA) JAUS transport protocol. The OCU can comprise, for example, a behavior system such as iRobot®'s Aware™ 2.0 behavior engine. The Aware™ 2.0 environment can include, for example, a JAUS gateway, an OCU framework, a 3D graphics engine, and device drivers. The OCU can also include an operating system such as, for example, an Ubuntu operating system (Linux), enclosed in a ruggedized device such as an Amrel Ruggedized Notebook.

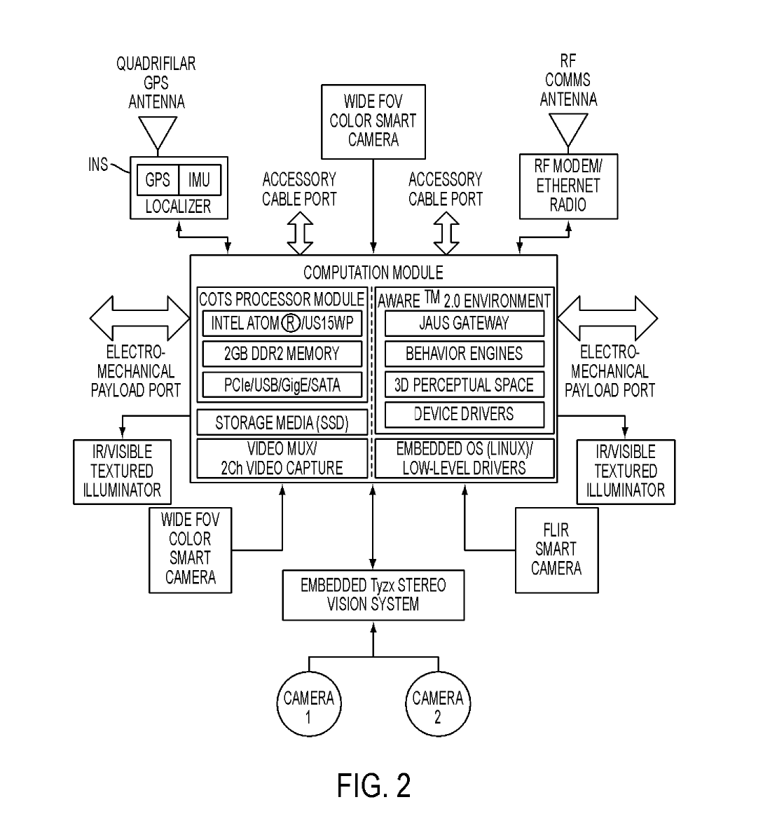

FIG. 2 is a schematic diagram of an exemplary embodiment of a system architecture for a payload in accordance with the present teachings. The internal architecture of the payload is focused around compact, thermally-capable packaging of high-performance, low-power computation and available sensory modules and components. The payload can integrate, for example, a Tyzx OEM stereo vision system including two cameras (e.g., Camera 1 and Camera 2 as illustrated) with a COTS processor along with several smart camera modules, illuminators, and other supporting electronics. The interface to the payload is preferably flexible, and can be facilitated by power and Ethernet links to the remote vehicle and a networked radio link between the payload and the OCU. Effectiveness of the payload can be achieved by tight integration and ruggedized packaging of core sensing, computation, and communications modules.

In various embodiments, the sensing modules can include, as illustrated in the embodiment of FIG. 2: (1) stereo vision for dense 3D sensing to feed the 3D local perceptual space; (2) multiple smart video (camera) sources to feed video with minimal power and computational overhead; (3) GPS/IMU for advanced high-performance position estimation; (4) an embedded high-performance computation module to provide 3D local perceptual space and autonomy; (5) an optional radio link (e.g., the illustrated communication antenna for an RF modem/Ethernet radio) that can simplify communications for evaluation and testing; and (6) controlled, textured illumination to eliminate failure modes of stereo vision. Stereo vision relies on texture features to extract depth information. When such features are sparse (a common condition in highly structured, smooth indoor environments), sufficient depth data may not be available. However, with the addition of software-controlled, “textured” illuminators, stereo vision can be made robust for use in all environments. The present teachings contemplate utilizing a laser scanning sensor such as LIDAR (not shown in the embodiment of FIG. 2) for range finding in addition to, or as an alternative to, a stereo vision camera.

In accordance with various embodiments, the COTS processor can comprise, for example, memory (e.g., the illustrated 2 GB DDR2 memory), bus interfaces including one or more of PCIe, USB, GigE, and SATA, a COTS ComExpress computational module based on an Intel® Atom processor. The smart camera modules can comprise, for example, two wide field-of-view (FOV) color smart cameras and an FLIR smart camera, as shown in the embodiment of FIG. 2. The illuminators can comprise, for example, two IR/visible textured illuminators as shown in FIG. 2. The system can additionally include, as shown in FIG. 2, one or more electro-mechanical payload ports to facilitate connection of devices (e.g., a chemical-biological detector, additional cameras, additional firing circuits, etc.), one or more accessory cable ports for facilitating connection of devices (e.g., chemical-biological detectors, radiological sensors, thermal cameras, fish eye cameras, etc.), a GPS/IMU module including an antenna such as a quadrifilar GPS antenna, and a localizer including a GPS and an IMU.

The computation module can comprise, for example, in addition to the COTS processor module, an embedded OS (e.g., Linux) with low-level drivers (e.g., for a laser scanner, stereo vision cameras, a pan/tilt, Ethernet switching, making sure components work and talk to each other, etc.), storage media (e.g., SDD) and a video multiplexer for 2-channel video capture. For embodiments where more than two video cameras are utilized with the payload, the video streams can be input to the multiplexer and only two default or selected video streams will be sent to the OCU display for viewing by the operator. One skilled in the art will understand that the present teachings are not limited to two video displays. Indeed, the present teachings contemplate using one or more video displays as is desirable by the designer and/or the operator. As shown in the embodiment of FIG. 2, the computation module can additionally include an “Aware™ 2.0 Environment” comprising a behavior engine, a JAUS gateway, a 3D local perceptual space, and one or more device drivers.

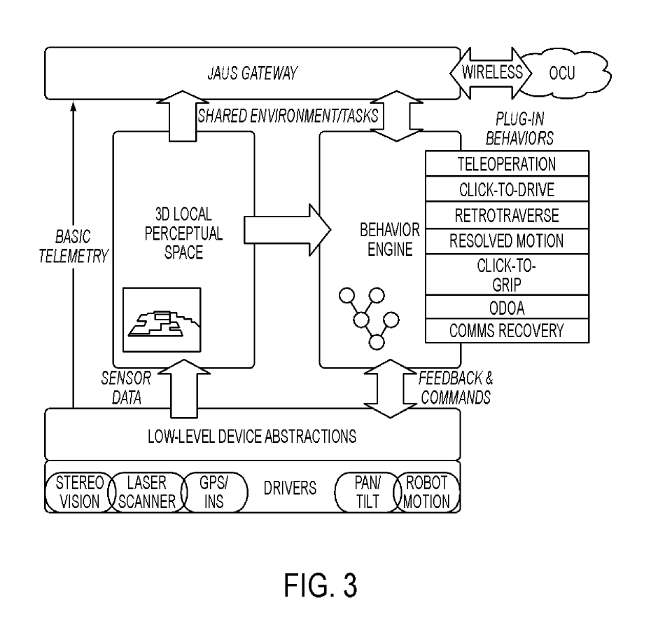

FIG. 3 is a schematic diagram of an exemplary embodiment of integration of a behavior engine (e.g., iRobot®'s Aware™ 2.0 behavior engine) and a JAUS gateway. The illustrated 3D local perceptual space can comprise a high-performance database that fuses localization sensors (e.g., GPS, IMU, and odometry) and ranging sensors (e.g., stereo vision, laser scanners, etc.) using fast geometric indexing and Bayesian evidence accumulation and scan registration functionality. The result is a fast, locally accurate 3D “model” of the environment that can be shared between behaviors and the operator.

The behavior engine can provide kinodynamic, real-time motion planning that accounts for the dynamics and kinematics of the underlying host vehicle, so that the individual behaviors don't need to deal with the dynamics and kinematics of the underlying host vehicle and thus are highly portable and easily reconfigured for operation on different remote vehicle type. Exemplary behavior engines are disclosed in U.S. Patent Publication No. 2009/0254217, filed Apr. 10, 2008, titled Robotics Systems, and U.S. Provisional Patent Application No. 61/333,541, filed May 11, 2010, titled Advanced Behavior Engine, the entire contents of which are incorporated herein be reference.

Both the 3D local perceptual space and the behavior engine can be interfaced to the JAUS Gateway as illustrated in the embodiment of FIG. 3. This arrangement can utilize the autonomous and/or semi-autonomous capabilities of the behavior engine using JAUS-based messaging to the OCU. In certain embodiments, JAUS-based messaging can be utilized for data that is defined by an existing JAUS Reference Architecture. In such embodiments, for some advanced capability, experimental messages can be utilized.

As shown in FIG. 3, the JAUS gateway can communicate wirelessly with the system OCU. In certain embodiments, the behavior engine can include plug-in behaviors such as, for example, teleoperation, click-to-drive, retrotraverse, resolved motion, click-to-manipulate, obstacle detection and obstacle avoidance (ODOA) and a communications recovery behavior. Low-level device abstractions can provide appropriate sensor data to the 3D local perceptual space, and can exchange feedback and comments with the behavior engine. The low-level device abstractions can sit atop device drivers, as shown in FIG. 3. The device drivers can comprise, for example, stereo vision device driver, a laser scanner device driver, an inertial navigation system (e.g., including a GPS, an IMU, and a localizer (software that uses input from GPS, IMU, odometer to figure out where the remote vehicle is) device driver, a pan/tilt device driver, and a robot motion device driver. In the embodiment of FIG. 3, basic telemetry information can be sent directly from the low-level device abstractions to the JAUS gateway.

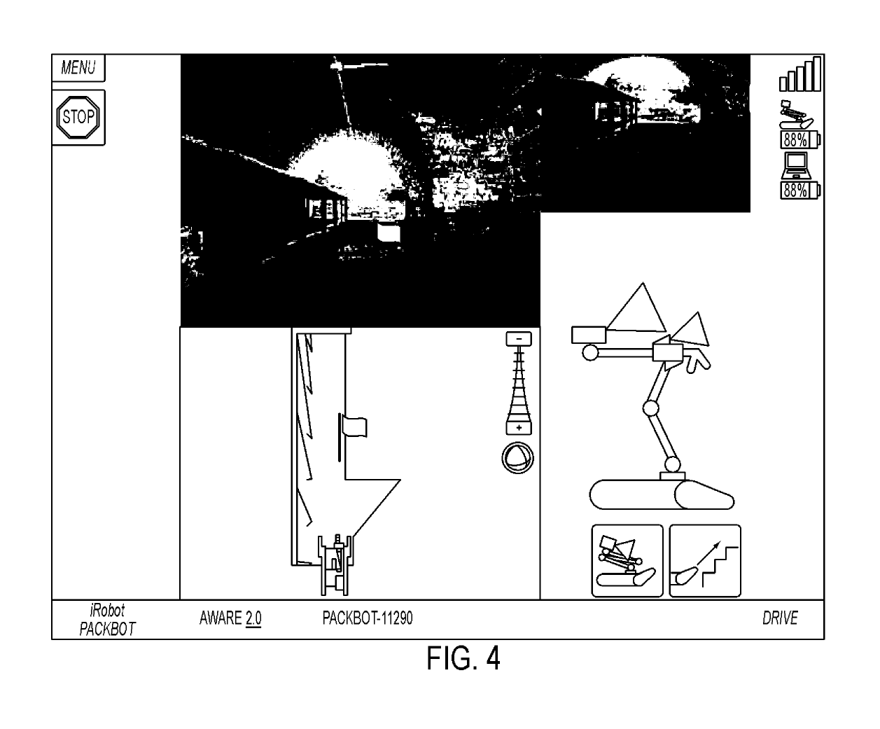

Various embodiments of the present teachings provide autonomous and/or semi-autonomous remote vehicle control by replacing teleoperation and manual “servoing” of remote vehicle motion with a seamless point-and-click operator interface paradigm. An exemplary embodiment of a point-and-click visual interface is illustrated in FIG. 4. The interface is designed so that an operator can issue high-level commands to the remote vehicle with just a few clicks for each high-level command.

In accordance with various embodiments of an interface of the present teachings, the first click selects the part of the remote vehicle that the operator wants to command. For example, clicking the remote vehicle's chassis selects the chassis and indicates that the operator wants to drive around, while clicking the remote vehicle's head camera indicates that the operator wants to look around. Clicking on the remote vehicle's hand indicates that the operator wants to manipulate an object, and then selection of an object in 3D space (e.g., by clicking on the map or on the two videos to allow triangulation from the video feed) determines the target of the remote vehicle's manipulator arm. Clicking on a part of the 3D environment can also show the distance between the end-effector and that part of the 3D environment. Exemplary click-to-grip and click-to-drive behaviors are disclosed in more detail in U.S. Patent Publication No. 2008/0086241, filed Apr. 10, 2008, the entire contents of which is incorporated herein be reference.

In an exemplary embodiment, to drive to a location, the operator clicks on the remote vehicle's chassis (to tell the system that he wants to drive the remote vehicle) and then clicks on a destination shown on a video display or on the map. A flag icon (see, e.g., the flag icon shown in the map of FIG. 4) can be overlaid on the map and/or the video display to indicate the destination toward which the remote vehicle will be moving based on operator's input, and the remote vehicle will move to the selected position. In accordance with certain embodiments, to zoom in on a video display, the operator can click on the remote vehicle's camera and then drag a box around the part of the video that the operator desires to view more closely. In certain embodiments, the operator can look at the map view from many perspectives by dragging on one or more widgets that will rotate and/or zoom the map. For example, the operator may wish to see the map from the remote vehicle's viewpoint.

In accordance with various embodiments, depending on the part of the remote vehicle selected, the system can display a list of autonomous and/or semi-autonomous behaviors that are available for that remote vehicle part. For example, if the operator clicks on the remote vehicle's chassis, the system can display at least a stair climbing button. The operator can select stairs for the remote vehicle to climb by clicking on the stairs in the video or on the map, and then the operator can press the stair climbing button to move the remote vehicle to the selected stairs and begin the stair climbing behavior. An exemplary stair climbing behavior is disclosed in more detail in U.S. Patent Publication No. 2008/0086241, filed Apr. 10, 2008, the entire contents of which is incorporated herein be reference.

In accordance with certain embodiments, the interface additionally display information regarding the remote vehicle's health or status, including a communication signal icon, a remote vehicle battery (power source) charge icon, and an OCU batter (power source) charge icon. These icons are shown in the upper right corner of FIG. 4. In addition, the interface can display a status of the remote vehicle for the operator, for example, drive (shown in the lower right corner of FIG. 4), manipulate, climb, etc. A menu button, shown in the upper left corner of FIG. 4, can open a menu for low-level functions that an operator typically does not use during a mission, for example login/logout and shut down functions. A stop button, shown in the upper left corner of FIG. 4, can stop the remote vehicle by, for example, turning a drive brake on or stopping every motor in the remote vehicle to cease all movement.

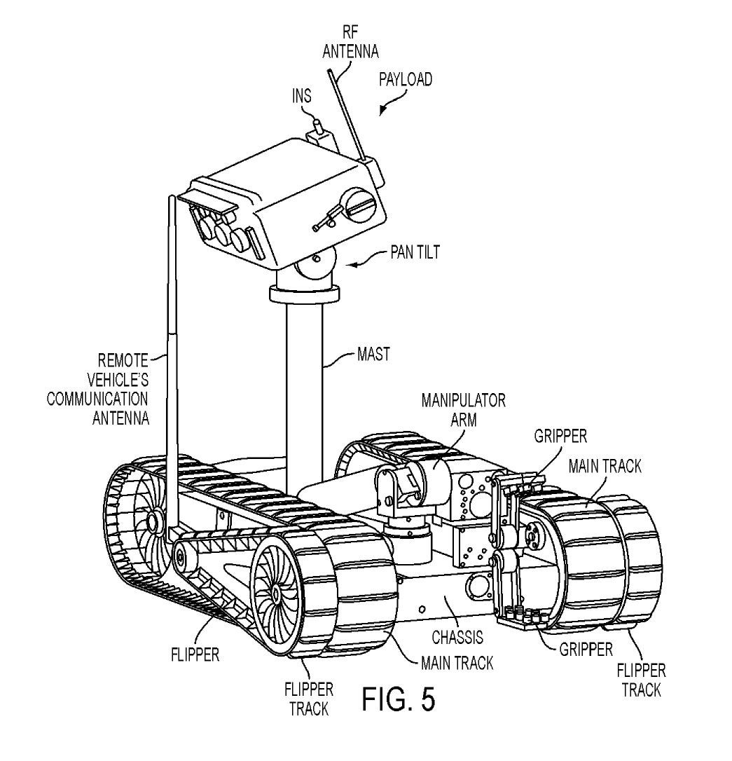

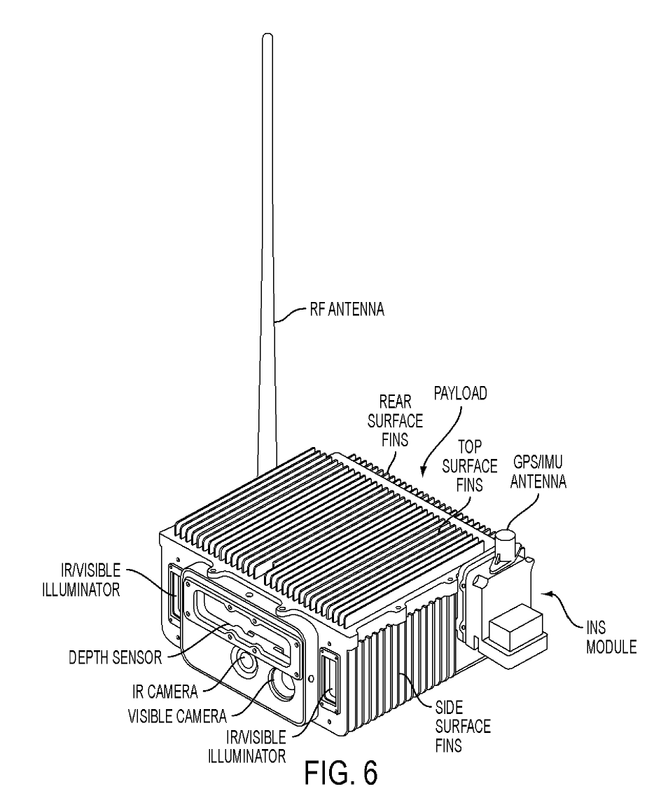

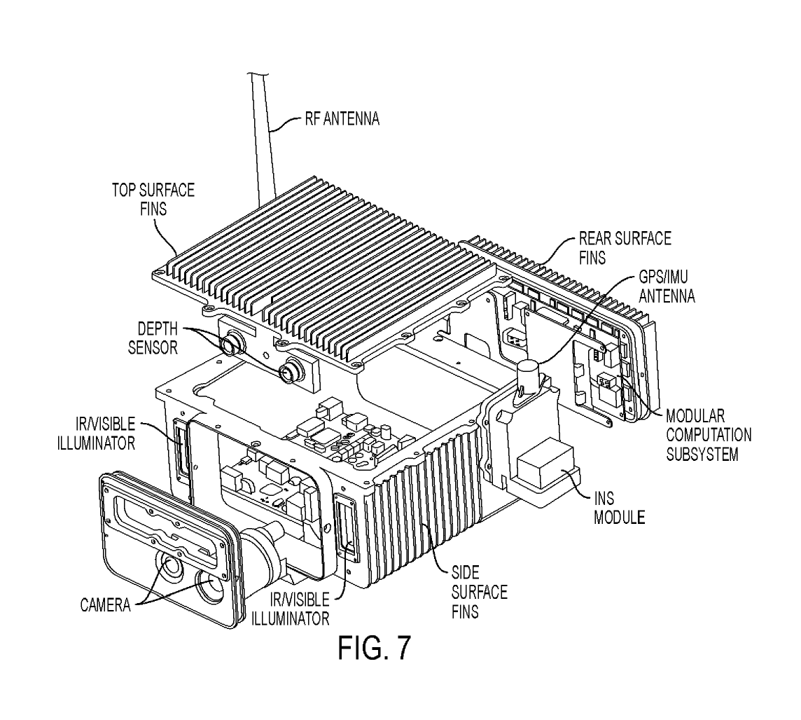

FIG. 5 is a plan view of an exemplary embodiment of a remote vehicle including a payload in accordance with the present teachings. The illustrated remote vehicle includes a chassis comprising main tracks and rotatable flippers having flipper tracks. The remote vehicle can include an antenna for communication with the OCU, and an arm having a manipulator attached to its distal end. The payload can be attached to the remote vehicle using, for example, a mast and a pan/tilt mechanism. The height of the mast may vary depending on the size and design of the remote vehicle, and also based on intended missions. The mast can be, for example about 2 to 3 feet in height for an iRobot® SUGV 310. The mast should be high enough for cameras and other sensors mounted thereon camera to get a good view of the remote vehicle's environment. The mast is preferably fixed to the remote vehicle chassis, and the remote vehicle manipulator arm can be positioned next to the mast. A remote vehicle manipulator arm can to extend to a height of, for example, about 2.5 to 3 feet. The details of a payload in accordance with the present teachings are discussed below with respect to FIGS. 6 and 7, which illustrate an exemplary embodiment of thereof.

FIG. 6 is a plan view of an exemplary embodiment of a payload in accordance with the present teachings, and FIG. 7 is an exploded view of the payload of FIG. 6. As can be seen, the illustrated exemplary payload comprises visible and infrared (IR) cameras for rich spectral data and material differentiation. Visible cameras can be used for well-lit environments, and IR cameras can be used for low-light environments. IR and visible illumination is provided for the visible and IR cameras. The illumination can comprise “textured” illumination to assist when stereo vision is employed. A 2D range/depth sensor is provided, for example a stereo vision system, a laser range finder (e.g., LIDAR), or a similar sensor. Data from the 2D range/depth sensor can be used, for example, for creation of the 3D local perceptual space, and for 3D models in certain behaviors such as a click-to-grip behavior. The 3D local perceptual space can be used, for example, in an object detection/object avoidance (ODOA) behavior and to build a map as shown in the interface.

In the illustrated embodiment, an integrated RF link can be used for communication between the payload and the OCU, which can facilitate control and command of the remote vehicle. The illustrated exemplary payload also comprises an inertial navigation system that includes, for example, a GPS and an IMU with localization algorithms. A modular computational subsystem is also provided in the payload. An exemplary embodiment of a modular computational subsystem is illustrated as the computation module in FIG. 2.

Various embodiments of the payload can include an integrated passive thermal heat sinking solution including at least the illustrated top, side, and rear heat-dissipating fins, as well as heat dissipating fins located on the side of the payload that is not illustrated. Fins may additionally be located on a bottom of the payload. Once skilled in the art will appreciate that the fins need not be provide on all of the external surfaces of the payload. Indeed, the present teachings contemplate providing heat-dissipating fins that cover enough area on the payload to dissipate the heat produced by a given payload.

The main housing of the payload can include expansive ports, for example for Ethernet, USB, and RS232, along with additional passive heat sinking. The payload preferably includes a sealed, rugged enclosure.

Other embodiments of the present teachings will be apparent to those skilled in the art from consideration of the specification and practice of the teachings disclosed herein. It is intended that the specification and examples be considered as exemplary only, with a true scope and spirit of the present teachings being indicated by the following claims.

What is claimed is:

1. A system for increasing an operator's situational awareness while the operator controls a remote vehicle, the system comprising:
an operator control unit having a point-and-click interface configured to allow the operator to view an environment surrounding the remote vehicle and control the remote vehicle by inputting one or more commands via the point-and-click interfaced; and
a payload attached to the remote vehicle and in communication with at least one of the remote vehicle and the operator control unit, the payload comprising
an integrated sensor suite including a global positioning system, an inertial measurement unit, and a stereo vision camera or a range sensor, and
a computational module receiving data from the integrated sensor suite and providing data to at least one of an autonomous behavior and a semi-autonomous behavior.

2. The system of claim 1, wherein the payload weighs less than about 10 pounds.

3. The system of claim 1, wherein the payload weighs less than about 5 pounds.

4. The system of claim 1, wherein the payload is mounted to a mast extending from a chassis of the remote vehicle.

5. The system of claim 4, wherein a pan/tilt mechanism is located between the payload and the mast.

6. The system of claim 1, wherein the operator control unit includes a map-based point-and-click user interface.

7. The system of claim 6, wherein the operator control unit displays a 3D local perceptual space.

8. The system of claim 1, wherein the computation module analyzes the data received from the integrated sensor suite.

9. The system of claim 1, wherein the payload monitors the remote vehicle's progress to ensure that the remote vehicle completes the comprising the one or more commands.

10. A system for increasing an operator's situational awareness while the operator controls a remote vehicle using at least one of an autonomous behavior and a semi-autonomous behavior, the system including a payload attached to the remote vehicle and in communication with the remote vehicle and the operator control unit, the payload comprising:
an integrated sensor suite including a global positioning system, an inertial measurement unit, one or more video cameras, and a stereo vision camera or a range sensor; and
a computational module receiving data from the integrated sensor suite, performing computations on at least some of the data, analyzing at least some of the data, and providing data to at least one of the autonomous behavior and the semi-autonomous behavior.

11. The system of claim 10, wherein the payload weighs less than about 10 pounds.

12. The system of claim 10, wherein the payload weighs less than about 5 pounds.

13. The system of claim 10, wherein the payload is mounted to a mast extending from a chassis of the remote vehicle.

14. The system of claim 13, wherein a pan/tilt mechanism is located between the payload and the mast.

15. The system of claim 10, wherein the payload monitors the remote vehicle's progress to ensure that the remote vehicle completes the tasks in the one or more commands.

16. A system for performing explosive ordnance disposal with a small unmanned ground vehicle using at least one of an autonomous behavior and a semi-autonomous behavior, the system including a payload attached to the remote vehicle and in communication with the remote vehicle and the operator control unit, the payload comprising:
an integrated sensor suite including a global positioning system, an inertial measurement unit, one or more video cameras, and a stereo vision camera or a range sensor; and
a computational module receiving data from the integrated sensor suite, performing computations on at least some of the data, analyzing at least some of the data, and providing data to at least one of the autonomous behavior and the semi-autonomous behavior,
wherein commands are sent from the OCU to the remote vehicle via the payload.

17. The system of claim 16, wherein the payload weighs less than about 10 pounds.

18. The system of claim 16, wherein the payload weighs less than about 5 pounds.

19. The system of claim 16, wherein the payload is mounted to a mast extending from a chassis of the remote vehicle.

20. The system of claim 19, wherein a pan/tilt mechanism is located between the payload and the mast.
